(19) United States
(12) Patent Application Publication
(10) Pub. No.: US 2025/0056075 A1
(43) Pub. Date: Feb. 13, 2025

(54) Methods, Devices, and Systems for Mid-Stream Content Delivery Network (CDN) Steering

(71) Applicant: Charter Communications Operating, LLC, St. Louis, MO (US)

(72) Inventors: Nikhil PARIKH, Arvada, CO (US); Erdogan SIMSEK, Englewood, CO (US); Jason DONOVAN, Denver, CO (US); Vipul PATEL, Parker, CO (US)

(21) Appl. No.: 18/232,886

(22) Filed: Aug. 11, 2023

(51) Int. Cl. H04N 21/262

(52) U.S. Cl. CPC H04N 21/262

(57) ABSTRACT

Various embodiments include systems and methods for performing mid-stream content delivery network (CDN) steering. A processing system in a manifest manipulator may receive a content request from a client device that is directed to obtain content from a uniform resource locator (URL) associated with a primary on-premise CDN. The processing system may also receive an event notification from a CDN decision server that indicates that there is an issue with the primary on-premise CDN. The processing system may modify a manifest file associated with the received content request in response to receiving the event notification from the CDN decision server, and send the modified manifest file to the client device to cause the client device to obtain the requested content from a third-party CDN.

### BACKGROUND

Content Delivery Networks (CDNs) play a significant role in ensuring a high-quality user experience for online video streaming services. As the demand for video content increases during high-profile streaming events (e.g., the Super Bowl), the need for CDNs to handle such heightened requests without interruptions becomes increasingly desired.

CDN steering is a technique for optimizing content delivery that involves intelligently routing traffic across different CDN providers or servers. These CDN steering operations may enhance user experience, reduce latency, and optimize resource utilization. They may also ensure that a user's content request is channeled to the most appropriate CDN point of presence (POP). Video streaming services may leverage CDN steering technologies to deliver content more consistently and with higher quality during peak streaming events. Effective CDN steering may enhance the efficiency and reliability of content delivery, thereby improving customer experience, especially during periods of high demand.

A variety of CDN steering techniques and technologies exist. One such method is client-side steering, which may include incorporating software into the client device that may select the most efficient CDN or server. This technique utilizes real-time data on network performance, device capabilities, and the user's geographic location, among other factors, to make informed decisions. While client-side steering may adapt swiftly to changing network conditions, it may also require specific compatibility on the client side.

Alternatively, DNS-based CDN steering operates at the server level. This technique may include a DNS server allocating the client to the most suitable CDN based on load and geographic proximity parameters. DNS-based CDN steering boasts widespread compatibility since it does not necessitate specific client-side software. However, DNS-based CDN steering may not offer the same dynamic response as client-side steering due to the inherent caching characteristics of DNS. Another server-side CDN steering method is HTTP Redirect-based steering, in which the server responds to the initial client request by redirecting it to the most appropriate CDN.

As online content, particularly video, becomes richer and more abundant, the demand for seamless, high-quality experiences intensifies. Service providers may be required to handle ever-increasing data volumes and deliver content to geographically dispersed users, often under challenging network conditions. In such conditions, traditional CDN steering methods may falter, leading to performance issues such as buffering or latency, which may compromise or degrade the user experience. As such, new and improved CDN steering solutions that offer intelligent, dynamic, and adaptable traffic management may better balance server loads, route data efficiently, mitigate network bottlenecks, and ultimately deliver a faster, more reliable, and smoother user experience.

### SUMMARY

Various aspects include methods of performing mid-stream content delivery network (CDN) steering, which may include receiving, by a processing system in a manifest manipulator computing device, a content request from a client device that may be directed to obtain content from a uniform resource locator (URL) associated with a primary on-premise CDN, receiving, by the processing system, an event notification that indicates an issue with the primary on-premise CDN from a CDN decision server, modifying, by the processing system, a manifest file associated with the received content request in response to receiving the event notification from the CDN decision server, and sending the modified manifest file to the client device to cause the client device to obtain the requested content from a third-party CDN.

In some aspects, modifying the manifest file associated with the received content request in response to receiving the event notification from the CDN decision server may include replacing a URL that points to the primary on-premise CDN with a URL that points to a third-party CDN.

Some aspects may further include receiving a second event notification from the CDN decision server that indicates that the issue with the primary on-premise CDN has been resolved, updating the modified manifest file in response to receiving the second event notification from the CDN decision server, and sending the updated modified manifest file to the client device to cause the client device to obtain a remaining portion of the requested content from the primary on-premise CDN.

In some aspects, sending the modified manifest file to the client device to cause the client device to obtain the requested content from a third-party CDN may include redirecting the client device from the primary on-premise CDN to the third-party CDN without disrupting an ongoing content stream on the client device.

In some aspects, receiving the event notification that indicates the issue with the primary on-premise CDN from the CDN decision server may include receiving data about a problematic market and a specific edge site experiencing difficulties.

Some aspects may further include modifying the manifest file based on real-time network conditions and a geographical location of the client device.

In some aspects, using the client-to-geolocation map to select the third-party CDN based on the current geographical location of the client device further may include using the client-to-geolocation map to improve a reliability of a streaming service.

Further aspects may include a computing device having a processor configured with processor-executable instructions to perform various operations corresponding to the methods discussed above.

Further aspects may include a computing device having various means for performing functions corresponding to the method operations discussed above.

Further aspects may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 illustrates an example communication system suitable for implementing the various embodiments.

FIG. 2 is an activity diagram illustrating operations and interactions between components in the example communication system configured to proactively monitor and dynamically adapt their operations to support the uninterrupted delivery of streaming content in accordance with the various embodiments.

FIG. 3 is a process flow diagram illustrating a method 300 of routing for content delivery based on real-time network conditions and the geographical location of the client to ensure an uninterrupted and high-quality content streaming experience in accordance with some embodiments.

FIGS. 4A and 4B illustrate methods of performing mid-stream content delivery network (CDN) steering in accordance with some embodiments.

FIG. 5 is a component diagram of a server suitable for implementing the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

In overview, various embodiments include methods, and computing devices that include processing systems configured to implement the methods, for performing dynamic content delivery network (CDN) steering in a streaming environment. Some embodiments may include a CDN decision server/service component that is configured to continuously or repeatedly monitor the performance of a primary on-premise CDN to detect various issues (e.g., market failure, overloading, etc.). For example, the CDN decision service may repeatedly or continuously poll the on-premise CDN for vital Key Performance Indicators (KPIs) such as load levels, system vitality, etc. The CDN decision service may generate event notification messages in response to detecting an issue with the primary on-premise CDN. If the CDN decision service detects an issue within a specific market based on the KPIs, the CDN decision service may log that event and communicate it to the manifest manipulator via a push notification that includes data about the problematic market and the specific edge site experiencing difficulties.

Subsequent instances in which a client device receives a request to obtain content from a URL associated with the primary on-premise CDN (and thus may send a request message to a manifest manipulator for an updated manifest file), the manifest manipulator may determine whether it received an event notification from the CDN decision service indicating an issue with the primary on-premise CDN. The manifest manipulator may dynamically modify the manifest file associated with the content request in response to determining that an event notification received from the CDN decision service indicates that there is an issue with the primary on-premise CDN. For example, the manifest manipulator may modify the manifest file by substituting URLs pointing to the primary on-premise CDN with URLs pointing to a third-party CDN. The manifest manipulator may send the modified manifest file to the client to redirect the client to obtain content from the third-party CDN instead of the primary on-premise CDN.

In some embodiments, the dynamic modification of the manifest file and subsequent redirection of the client may occur mid-stream without disrupting the client's content streaming experience. In some embodiments, the manifest manipulator may maintain and use a client-to-geolocation map to improve or optimize the redirection to the third-party CDN based on the geographical location of the client device.

The CDN decision service may continue monitoring the primary on-premise CDN to determine whether the identified issue has been resolved. In instances in which the identified issue is resolved, the CDN decision service may notify the manifest manipulator, which may readjust the manifest file to redirect the client back to the primary on-premise CDN.

The term “computing device” may be used herein to refer to any one or all of quantum computing devices, edge devices, Internet access gateways, modems, routers, network switches, residential gateways, access points, integrated access devices (IAD), mobile convergence products, networking adapters, multiplexers, personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems (e.g., PlayStation®, Xbox®, Nintendo Switch®, etc.), wearable devices (e.g., smartwatch, head-mounted display, fitness tracker, etc.), media players (e.g., DVD players, ROKU®, AppleTV®, etc.), digital video recorders (DVRs), automotive displays, portable projectors, 3D holographic displays, and other similar devices that include a display and a programmable processor that can be configured to provide the functionality of various embodiments.

A technical challenge in systems that stream IP content is overcoming the occasional buffering or degradation in video quality or disruptions caused by limitations in the Content Delivery Network (CDN). A CDN is a system of distributed servers that delivers pages and other web content to users based on factors like their geographic locations, the origin of the webpage, and the content delivery server. In the context of video streaming, the CDN may play a significant role in ensuring a smooth and high-quality viewing experience. In instances in which the CDN faces issues such as market overloads or server failures, the end result is often an interruption or degradation in the streaming quality.

Related solutions for video streaming determine the CDN to serve the content at the start of the streaming process. In such related solutions, the selected CDN remains unchanged throughout the entire stream. Such a static approach may result in technical problems when unexpected issues arise during the stream and may lead to interruptions or degraded quality of the streamed content.

The embodiments disclosed herein may include components configured to proactively monitor and dynamically adapt to ensure the uninterrupted delivery of streaming content. Unlike related solutions that determine the CDN at the start of the streaming process and do not change the selected CDN, various embodiments disclosed herein may include a CDN decision service that continuously monitors the operational status of the on-premise CDN and triggers an event notification to the manifest manipulator upon detecting potential issues. In response to detecting the event notification, the manifest manipulator dynamically adjusts the manifest files that guide clients to the source of their content. Rather than directing them to a potentially overloaded or failing on-premise CDN, the manifest manipulator redirects the requests mid-stream to a third-party CDN. This redirection may be accomplished without interrupting the streaming experience for the user, maintaining a high-quality, consistent content delivery.

Various embodiments disclosed herein may also include the ability to manage changes to the routing mid-stream. The embodiments do not require that the user stop the stream, exit the app, or switch channels to connect to a new CDN. This intelligent and seamless adaptability of the solution may dramatically improve user experience and service reliability.

In addition, the integration and use of a client site map that maps client subnets to specific edge sites on the on-premise CDN in accordance with the embodiments may further refine the efficiency of the system. Various embodiments may provide the manifest manipulator with essential information to make even more informed decisions about the best content source for each client. The components identify and respond to problems as they arise and also minimize the likelihood of problems arising.

These operations may improve the reliability of the on-premise CDN for streaming services. For example, these operations allow the manifest manipulator to steer clients away from the on-premise CDN and towards a third-party CDN seamlessly, in the midst of ongoing streams, so as to ensure that the customer's viewing experience remains unimpaired, even during periods of instability within our own CDN infrastructure. For these and other reasons, various embodiments disclosed herein may improve the performance and/or functioning of the components and network. Other improvements to the performance and/or functioning of the components or network will be evident from the disclosures below.

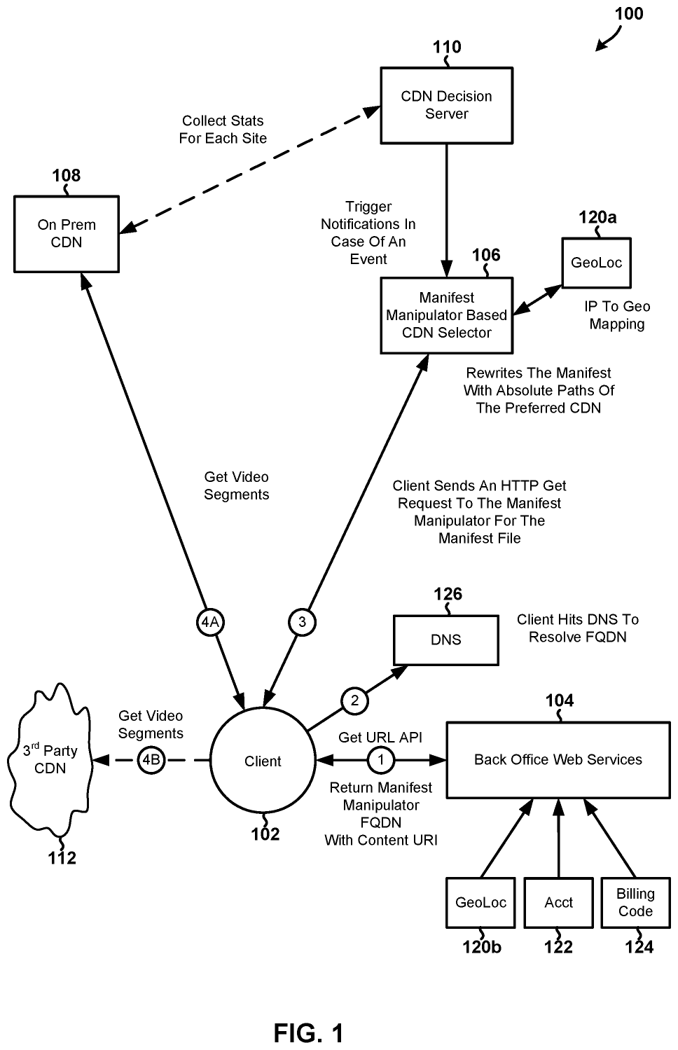

FIG. 1 illustrates an example system 100 suitable for implementing the various embodiments. In the example illustrated in FIG. 1, the system 100 may include a client 102, an back office web services 104 component, a manifest manipulator based CDN selector 106, an on-premise CDN 108, a CDN decision server 110, a third party CDN 112, Geolocation (GeoLoc) 120a, 120b components, an account 122 component, a billing code 124 component, and a Domain Name System (DNS) 126 component.

In overview, the system 100 may be configured so that, depending on the status of the on-premise CDN 108, the client 102 may get video segments from either the on-premise CDN 108 or the third-party CDN 112. This, in turn, may ensure a seamless streaming experience for the user irrespective of any potential issues with the primary content delivery network.

The client 102 device may be any device that is used to access or retrieve digital content, such as a computer, smartphone, smart TV, or any other internet-enabled device. The client 102 may send out a “content request” when a user wishes to access specific content, be it a video stream or a web resource. The specific content may be identified via a Uniform Resource Locator (URL), which may serve as a precise internet address pointing to the content's location on the web.

The client 102 component may receive requests for content from users and forward the requests to the manifest manipulator 106 component. The client 102 component may also receive a modified manifest file from the manifest manipulator 106 and redirect it to a content source defined in the manifest file.

The back office web services 104 component may operate as a back-end system that supports all the administrative functionalities, such as the account and billing information.

The manifest manipulator 106 component may be configured to receive content requests from client 102 and determine whether it received an event notification from the CDN decision service 110 about issues with the primary on-premise CDN 108. In response to determining that it received an event notification from the CDN decision service 110, the manifest manipulator 106 may modify the manifest file to redirect the client to a third-party CDN 112. The manifest manipulator 106 may also use a client-to-geolocation map to improve the redirection based on the client's geographical location.

The on-premise CDN 108 component may be the primary content delivery network that serves the content to the client 102. The on-premise CDN 108 component may be continuously monitored by the CDN decision service 110 for potential issues.

The CDN decision server 110 may be a component in a CDN infrastructure that oversees the performance and operational status of the network. The CDN decision server 110 may include the capability to monitor KPIs such as load levels, system health, and availability of servers across various locations or markets to detect potential issues such as server overload, network failure, or suboptimal performance in a particular market or a specific edge site. An edge site may be a specific geographical location in which a CDN server or cluster of servers (also known as an edge server) is/are positioned. An edge server may be responsible for serving content to users that are proximate to the edge server. In this manner, latency may be reduced and the swift delivery of content may be ensured. In instances in which the CDN decision server 110 identifies an issue with the primary on-premise CDN 108, such as a network failure or server overload, the CDN decision server 110 may generate an event notification that includes data about the problematic area, such as details about the market (i.e., the geographical location or specific user segment) where the issue has occurred. The CDN decision server 110 may also provide information about the specific edge site experiencing difficulties. This information may include the server's identity, its load status, and the nature of the issue. Depending on the severity and type of the problem, the processing system may use this information to make adjustments to mitigate the issue. For example, the manifest manipulator may write the manifest with absolute paths of the video segments that may point to another CDN. This may ensure that content delivery to the end user at the client 102 remains seamless and uninterrupted, irrespective of any issues within the primary on-premise CDN 108.

The CDN decision server 110 may continuously monitor the on-premise CDN 108 for various issues, such as market failure, overloading, etc., and generate event notification messages if any issues are detected. The CDN decision server 110 may continue to monitor the on-premise CDN 108 and notify the manifest manipulator 106 to redirect the client 102 back to the primary on-premise CDN 108 after the issues have been resolved.

The third-party CDN 112 may operate to serve as an alternative content delivery network. In instances in which the primary on-premise CDN 108 encounters issues (e.g., market failure, overloading, etc.), client 102 is redirected to the third-party CDN 112 to obtain the requested content.

The geolocation (GeoLoc) 120a, 120b components may be configured to provide geolocation services to help the system 100 improve the redirection of the client 102 based on geographical location.

The account 122 component may be configured to manage user account information, such as login credentials, user profiles, and preferences.

The billing code 124 component may be configured to handle the billing operations related to the content delivery, such as subscription plans, payment processing, and invoice generation.

The DNS 126 component may be configured to translate domain names into IP addresses to facilitate content delivery across the network. The DNS 126 component may also work closely with the manifest manipulator 106 to help direct content requests to the appropriate CDN (e.g., 108 or 112).

In the example illustrated in FIG. 1, in operation 1, the client 102 may send a request to the Get URL API to the back office web services 104. This request may ask the service for the necessary information to access the desired content. In response, the back office web services 104 may return a Fully Qualified Domain Name (FQDN) of the manifest manipulator 106 along with the content Uniform Resource Identifier (URI). The FQDN may be the complete domain name for a specific computer or host on the internet, or in this case, the manifest manipulator 106. The content URI may be a string of characters that identifies the desired content.

In operation 2, the client 102 may receive the FQDN and contact the DNS 126 to resolve the FQDN into its corresponding IP address. The DNS 126 may translate human-friendly domain names into the numeric IP addresses that computers use to communicate with each other.

In operation 3, the client 102 may obtain the IP address of the manifest manipulator 106 and send an HTTP GET request to the manifest manipulator 106 for the manifest file. A manifest file may be a text file that contains information about the media content (e.g., URLs of the individual media segments, etc.). Concurrently, the CDN decision server 110 may continuously collect stats about each site in the on-premise CDN 108 to monitor its performance. In instances in which the CDN decision server 110 detects an event (e.g., an overload or failure), the CDN decision server 110 may send a notification to the manifest manipulator 106. The manifest manipulator 106 may use IP to Geo Mapping in conjunction with GeoLoc 120a to determine the client's 102 geographical location. Based on this information and the event notification from the CDN Decision Server 110, the manifest manipulator 106 may rewrite the manifest file to include absolute paths of the preferred CDN (e.g., the on-premise CDN 108 or the third-party CDN 112).

The system may perform operation 4A or 4B depending on the paths specified in the rewritten manifest file. In operation 4A, client 102 may communicate directly with the on-premise CDN 108 to download the individual video segments. In operation 4A, client 102 continues to get video segments from the on-premise CDN 108. Alternatively, if there is an issue with the on-premise CDN 108, in operation 4B the client 102 may communicate directly with the third-party CDN 112 to download the individual video segments.

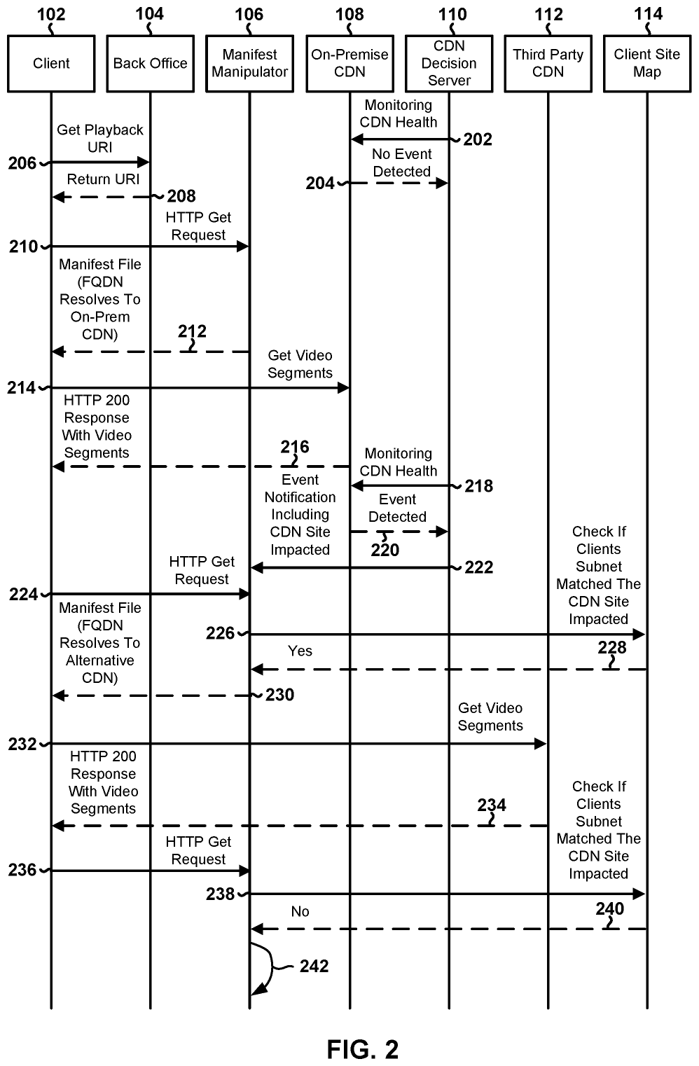

FIG. 2 is an activity diagram illustrating operations and interactions between components in a system configured to proactively monitor and dynamically adapt their operations to support the uninterrupted delivery of streaming content in accordance with the various embodiments. Each operation 202-242 represents a request, a response, or a process initiated by a component 102-114 to ensure improved content delivery to the client 102 devices.

In operation 202, the CDN decision server 110 may initiate a ‘Monitor CDN Health’ process directed at the on-premise CDN 108. In operation 204, the on-premise CDN 108 may respond with a ‘No Event Detected’ status, indicating normal operational parameters, and transmit this to the CDN decision server 110.

In operation 206, the client 102 may send a ‘Get Playback URI’ request to the back office web services 104 component. In response, the back office web services 104 component may return a Uniform Resource Identifier (URI) to the client 102 in operation 208.

In operation 210, the client 102 may send an ‘HTTP Get Request’ to the manifest manipulator 106. In operation 212, the manifest manipulator 106 may respond by sending a manifest file in which the FQDN resolves to the on-premise CDN 108 to the client 102.

In operation 214, the client 102 may send a ‘Get Video Segments’ request to the on-premise CDN 108. In operation 216, the on-premise CDN 108 may respond with an ‘HTTP 200’ response carrying the requested video segments (which are sent to the client 102).

In operation 218, the CDN decision server 110 may initiate a new ‘Monitor CDN Health’ process with the on-premise CDN 108. In operation 220, the on-premise CDN 108 may send an ‘Event Detected’ status to the CDN decision server 110, indicating an issue or anomaly in the CDN's performance. In operation 222, the CDN decision server 110 may send an ‘Event Notification Including CDN Site Impacted’ to the manifest manipulator 106.

In operation 224, the client 102 may send another ‘HTTP Get Request’ to the manifest manipulator 106. In operation 226, the manifest manipulator 106 may communicate with the client site map 114 to determine whether the client's subnet matches the impacted CDN site. In operation 228, the client site map 114 may send an affirmative ‘Yes’ response to the manifest manipulator 106, confirming a match.

In operation 230, the manifest manipulator 106 may send a revised manifest file to the client 102 in which the FQDN now resolves to an alternative CDN, specifically the third-party CDN 112. In operation 232, the client 102 may send a ‘Get Video Segments’ request to the third-party CDN 112. In operation 234, the third-party CDN 112 may respond with an ‘HTTP 200’ response that includes the requested video segments (which are sent to the client 102).

In operation 236, the client 102 may send another ‘HTTP Get Request’ to the manifest manipulator 106. In operation 238, the manifest manipulator 106 may communicate with the client site map 112 to determine whether the client's subnet matches the previously impacted CDN site. In operation 240, the client site map 114 may send a negative ‘No’ response to the manifest manipulator 106, indicating no match. In operation 242, the manifest manipulator 106 may commence a process to determine the next appropriate CDN for content delivery, based on the updated status and network conditions.

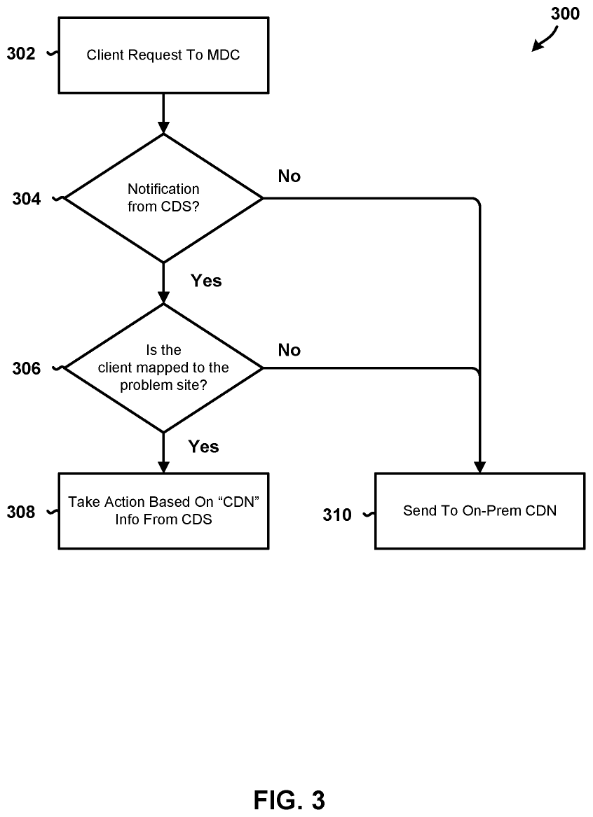

FIG. 3 is a process flow diagram illustrating a method 300 of routing for content delivery based on real-time network conditions and the geographical location of the client to ensure an uninterrupted and high-quality content streaming experience in accordance with some embodiments. Method 300 may be performed by a processor or processing system in a computing system.

In block 302, a client (e.g., client 102) may initiate a “Request to Manifest Delivery Controller (MDC)” for content. In determination block 304, the manifest manipulator may check whether there is an Event Notification from CDN decision server (CDS). In response to determining that there is no Event Notification (i.e., determination block 304=“No”), the system may determine that there are no issues detected within the network, and the client may be directed to the on-premise CDN for content delivery in block 310.

In response to determining that there is an Event Notification (i.e., determination block 304=“Yes”), the system may determine that there is a network issue and determine whether the client's geographical location or subnet is mapped to the problem site (the site with reported issues) in determination block 306.

In response to determining that the client's geographical location or subnet is not mapped to the problem site (i.e., determination block 306=“No”), the system may determine that the client is not mapped to the problem site, and the client may be directed to the on-premise CDN for content delivery in block 310.

In response to determining that the client's geographical location or subnet is mapped to the problem site (i.e., determination block 306=“Yes”), the system may determine that client is mapped to the problem site and initiate an action based on the CDN-related information from the CDN Decision Server (CDS) in block 308. In some embodiments, the initiated action may include redirecting the client to an alternative CDN (e.g., third-party CDN, etc.) for content delivery.

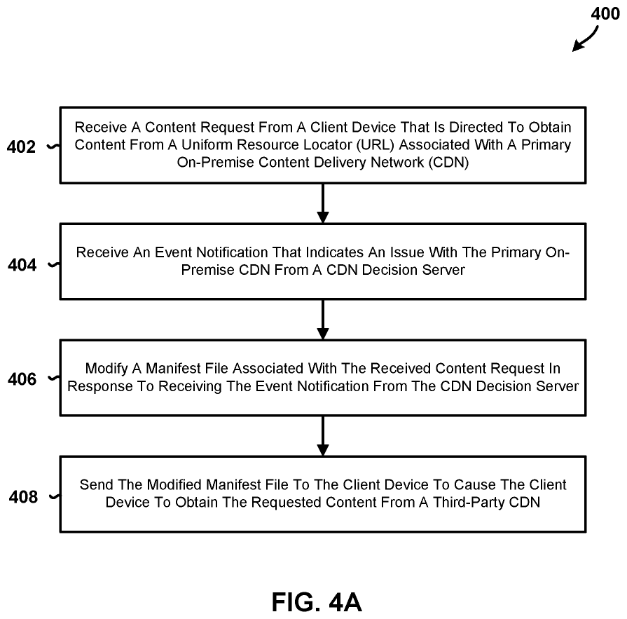

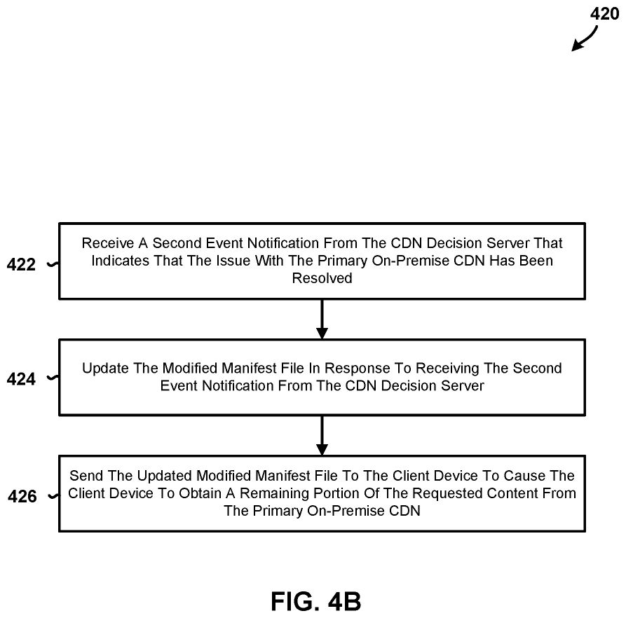

FIGS. 4A and 4B illustrate methods 400, 420 of performing mid-stream content delivery network (CDN) steering in accordance with some embodiments. Methods 400, 420 may be performed by a processor or processing system in a computing system, such as the processor located in the Manifest Manipulator 106.

In block 402, the processing system may receive a content request from a client device 102 that is directed to obtain content from a uniform resource locator (URL) associated with a primary on-premise CDN 108.

In block 404, the processing system may receive an event notification that indicates an issue with the primary on-premise CDN 108 from a CDN decision server 110. In some embodiments, receiving the event notification may include receiving data about a problematic market and a specific edge site experiencing difficulties.

In block 406, the processing system may modify a manifest file associated with the received content request in response to receiving the event notification from the CDN decision server 110. In some embodiments, the processing system may modify the manifest file associated with the received content request by replacing a URL that points to the primary on-premise CDN 108 with a URL that points to a third-party CDN 112. In some embodiments, the processing system may modify the manifest file based on real-time network conditions and a geographical location of the client device 102.

In block 408, the processing system may send the modified manifest file to the client device 102 to cause the client device 102 to obtain the requested content from a third-party CDN 112. In some embodiments, sending the modified manifest file to the client device 102 may include redirecting the client device 102 from the primary on-premise CDN 108 to the third-party CDN 112 without disrupting an ongoing content stream on the client device.

In some embodiments, method 400 may further include using a client-to-geolocation map to select the third-party CDN 112 based on a current geographical location of the client device 102. In some embodiments, the processing system may use the client-to-geolocation map to improve the reliability of a streaming service and/or to reduce the probability of errors in the system.

With reference to FIG. 4B, in block 422, the processing system may receive a second event notification from the CDN decision server 110 that indicates that the issue with the primary on-premise CDN 108 has been resolved.

In block 424, the processing system may update the modified manifest file in response to receiving the second event notification from the CDN decision server 110.

In block 426, the processing system may send the updated modified manifest file to the client device 102 to cause the client device 102 to obtain a remaining portion of the requested content from the primary on-premise CDN 108.

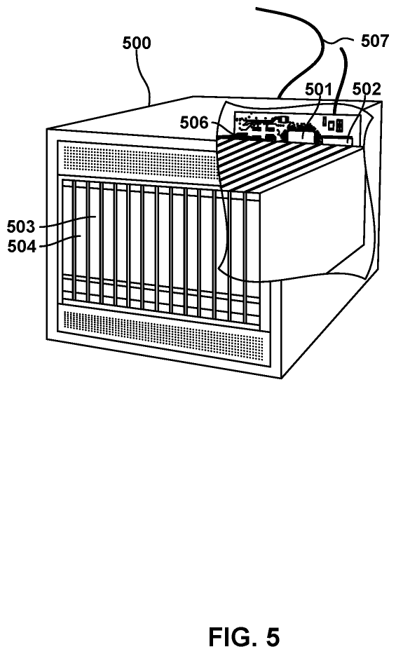

Some embodiments may be implemented on any of a variety of commercially available computing devices, such as the server computing device 500 illustrated in FIG. 5. Such a server device 500 may include a processor 501 coupled to volatile memory 502 and a large capacity nonvolatile memory, such as a disk drive 503. The server device 500 may also include a floppy disc drive, USB, etc. coupled to the processor 501. The server device 500 may also include network access ports 506 coupled to the processor 501 for establishing data connections with a network connection circuit 504 and a communication network (e.g., IP network) 507 coupled to other communication system network elements. In some embodiments, processor 501 may include a processing system. In some embodiments, processor 501 may be included as part of a processing system.

The processors, processing systems, or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

In some embodiments, the processing systems discussed in this application may be, or may include, a system on chip (SoC) or system in a package (SIP). An SOC may be a single integrated circuit (IC) chip that contains multiple resources or independent processors integrated on a single substrate. A single SoC may contain circuitry for digital, analog, mixed-signal, and radio-frequency functions. A single SoC also may include any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. SoCs also may include software for controlling integrated resources and processors, as well as for controlling peripheral devices. A SIP may be a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

It should be understood that in addition to the example SOC and SIP discussed above, various embodiments may be implemented in a wide variety of computing systems, which may include a single processor, multiple processors, multicore processors, or any combination thereof.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method of performing mid-stream content delivery network (CDN) steering, including receiving, by a processing system in a manifest manipulator computing device, a content request from a client device that is directed to obtain content from a uniform resource locator (URL) associated with a primary on-premise CDN, receiving, by the processing system, an event notification that indicates an issue with the primary on-premise CDN from a CDN decision server, modifying, by the processing system, a manifest file associated with the received content request in response to receiving the event notification from the CDN decision server, and sending the modified manifest file to the client device to cause the client device to obtain the requested content from a third-party CDN.

Example 2: The method of example 1, in which modifying the manifest file associated with the received content request in response to receiving the event notification from the CDN decision server includes replacing a URL that points to the primary on-premise CDN with a URL that points to a third-party CDN.

Example 3: The method of any of the examples 1 or 2, further including receiving a second event notification from the CDN decision server that indicates that the issue with the primary on-premise CDN has been resolved, updating the modified manifest file in response to receiving the second event notification from the CDN decision server, and sending the updated modified manifest file to the client device to cause the client device to obtain a remaining portion of the requested content from the primary on-premise CDN.

Example 4: The method of any of the examples 1-3, in which sending the modified manifest file to the client device to cause the client device to obtain the requested content from a third-party CDN includes redirecting the client device from the primary on-premise CDN to the third-party CDN without disrupting an ongoing content stream on the client device.

Example 5: The method of any of the examples 1-4, in which receiving the event notification that indicates the issue with the primary on-premise CDN from the CDN decision server includes receiving data about a problematic market and a specific edge site experiencing difficulties.

Example 6: The method of any of the examples 1-5, in which modifying the manifest file associated with the received content request in response to receiving the event notification from the CDN decision server further includes modifying the manifest file based on real-time network conditions and a geographical location of the client device.

Example 7: The method of any of the examples 1-6, further including using a client-to-geolocation map to select the third-party CDN based on a current geographical location of the client device.

Example 8: The method of example 7, in which using the client-to-geolocation map to select the third-party CDN based on the current geographical location of the client device further includes using the client-to-geolocation map to improve a reliability of a streaming service.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of distinct types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudo-static random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in or by a vehicle's advanced driver assistance system (ADAS), system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of performing mid-stream content delivery network (CDN) steering, comprising:
receiving, by a processing system in a manifest manipulator computing device, a content request from a client device that is directed to obtain content from a uniform resource locator (URL) associated with a primary on-premise CDN;
receiving, by the processing system, an event notification that indicates an issue with the primary on-premise CDN from a CDN decision server;
modifying, by the processing system, a manifest file associated with the received content request in response to receiving the event notification from the CDN decision server; and
sending the modified manifest file to the client device to cause the client device to obtain the requested content from a third-party CDN.

2. The method of claim 1, wherein modifying the manifest file associated with the received content request in response to receiving the event notification from the CDN decision server comprises replacing a URL that points to the primary on-premise CDN with a URL that points to the third-party CDN.

3. The method of claim 1, further comprising:
receiving a second event notification from the CDN decision server that indicates that the issue with the primary on-premise CDN has been resolved;
updating the modified manifest file in response to receiving the second event notification from the CDN decision server; and
sending the updated modified manifest file to the client device to cause the client device to obtain a remaining portion of the requested content from the primary on-premise CDN.

4. The method of claim 1, wherein sending the modified manifest file to the client device to cause the client device to obtain the requested content from the third-party CDN comprises redirecting the client device from the primary on-premise CDN to the third-party CDN without disrupting an ongoing content stream on the client device.

5. The method of claim 1, wherein receiving the event notification that indicates the issue with the primary on-premise CDN from the CDN decision server comprises receiving data about a problematic market and a specific edge site experiencing difficulties.

6. The method of claim 1, wherein modifying the manifest file associated with the received content request in response to receiving the event notification from the CDN decision server further comprises modifying the manifest file based on real-time network conditions and a geographical location of the client device.

7. The method of claim 1, further comprising using a client-to-geolocation map to select the third-party CDN based on a current geographical location of the client device.

8. The method of claim 7, wherein using the client-to-geolocation map to select the third-party CDN based on the current geographical location of the client device further comprises using the client-to-geolocation map to improve a reliability of a streaming service.

9. A computing device, comprising:
a processing system configured to:
receive a content request from a client device that is directed to obtain content from a uniform resource locator (URL) associated with a primary on-premise content delivery network (CDN);
receive an event notification that indicates an issue with the primary on-premise CDN from a CDN decision server;
modify a manifest file associated with the received content request in response to receiving the event notification from the CDN decision server; and
send the modified manifest file to the client device to cause the client device to obtain the requested content from a third-party CDN.

10. The computing device of claim 9, wherein the processing system is configured to modify the manifest file associated with the received content request in response to receiving the event notification from the CDN decision server by replacing a URL that points to the primary on-premise CDN with a URL that points to the third-party CDN.

11. The computing device of claim 9, wherein the processing system is further configured to:
receive a second event notification from the CDN decision server that indicates that the issue with the primary on-premise CDN has been resolved;
update the modified manifest file in response to receiving the second event notification from the CDN decision server; and
send the updated modified manifest file to the client device to cause the client device to obtain a remaining portion of the requested content from the primary on-premise CDN.

12. The computing device of claim 9, wherein the processing system is configured to send the modified manifest file to the client device to cause the client device to obtain the requested content from the third-party CDN by redirecting the client device from the primary on-premise CDN to the third-party CDN without disrupting an ongoing content stream on the client device.

13. The computing device of claim 9, wherein the processing system is configured to receive the event notification that indicates the issue with the primary on-premise CDN from the CDN decision server by receiving data about a problematic market and a specific edge site experiencing difficulties.

14. The computing device of claim 9, wherein the processing system is configured to modify the manifest file associated with the received content request in response to receiving the event notification from the CDN decision server by modifying the manifest file based on real-time network conditions and a geographical location of the client device.

15. The computing device of claim 9, wherein the processing system is further configured to using a client-to-geolocation map to select the third-party CDN based on a current geographical location of the client device.

16. The computing device of claim 15, wherein the processing system is configured to use the client-to-geolocation map to select the third-party CDN based on the current geographical location of the client device further by using the client-to-geolocation map to improve a reliability of a streaming service.

17. A non-transitory processor-readable medium having stored thereon processor-executable instructions configured to cause a processing system of a computing device to perform operations for mid-stream content delivery network (CDN) steering, the operations comprising:
receive a content request from a client device that is directed to obtain content from a uniform resource locator (URL) associated with a primary on-premise CDN;
receive an event notification that indicates an issue with the primary on-premise CDN from a CDN decision server;
modify a manifest file associated with the received content request in response to receiving the event notification from the CDN decision server; and
send the modified manifest file to the client device to cause the client device to obtain the requested content from a third-party CDN.

18. The non-transitory processor-readable medium of claim 17, wherein the stored processor-executable instructions are further configured to cause the processing system to perform operations such that modifying the manifest file associated with the received content request in response to receiving the event notification from the CDN decision server comprises replacing a URL that points to the primary on-premise CDN with a URL that points to the third-party CDN.

19. The non-transitory processor-readable medium of claim 17, wherein the stored processor-executable instructions are further configured to cause the processing system to perform operations further comprising:
receiving a second event notification from the CDN decision server that indicates that the issue with the primary on-premise CDN has been resolved;
updating the modified manifest file in response to receiving the second event notification from the CDN decision server; and
sending the updated modified manifest file to the client device to cause the client device to obtain a remaining portion of the requested content from the primary on-premise CDN.

20. The non-transitory processor-readable medium of claim 17, wherein the stored processor-executable instructions are further configured to cause the processing system to perform operations such that sending the modified manifest file to the client device to cause the client device to obtain the requested content from the third-party CDN comprises redirecting the client device from the primary on-premise CDN to the third-party CDN without disrupting an ongoing content stream on the client device.

21. The non-transitory processor-readable medium of claim 17, wherein the stored processor-executable instructions are further configured to cause the processing system to perform operations such that receiving the event notification that indicates the issue with the primary on-premise CDN from the CDN decision server comprises receiving data about a problematic market and a specific edge site experiencing difficulties.

22. The non-transitory processor-readable medium of claim 17, wherein the stored processor-executable instructions are further configured to cause the processing system to perform operations such that modifying the manifest file associated with the received content request in response to receiving the event notification from the CDN decision server further comprises modifying the manifest file based on real-time network conditions and a geographical location of the client device.

23. The non-transitory processor-readable medium of claim 17, wherein the stored processor-executable instructions are further configured to cause the processing system to perform operations further comprising using a client-to-geolocation map to select the third-party CDN based on a current geographical location of the client device.

24. The non-transitory processor-readable medium of claim 23, wherein the stored processor-executable instructions are further configured to cause the processing system to perform operations such that using the client-to-geolocation map to select the third-party CDN based on the current geographical location of the client device further comprises using the client-to-geolocation map to improve a reliability of a streaming service.
